(19) United States
(12) Patent Application Publication
(10) Pub. No.: US 2024/0349982 A1
(43) Pub. Date: Oct. 24, 2024

(54) ADHESIVE WIPING CLOTH

(71) Applicant: CHIH-PING WEI, TAINAN CITY (TW)

(72) Inventor: CHIH-PING WEI, TAINAN CITY (TW)

(21) Appl. No.: 18/303,135

(22) Filed: Apr. 19, 2023

(51) Int. Cl. A47L 25/00; C09J 7/21; C09J 7/38; D06N 3/00; D06N 3/04

(52) U.S. Cl. CPC A47L 25/005; C09J 7/21; C09J 7/381; D06N 3/0006; D06N 3/0009; D06N 3/009; D06N 3/045; C09J 2431/00; D06N 2209/046; D06N 2209/16; D06N 2211/08

(57) ABSTRACT

An adhesive wiping cloth is provided. The adhesive wiping cloth mainly includes a cloth layer and an oily vinyl acetate copolymer resin-based adhesive layer. The oily vinyl acetate copolymer resin-based adhesive layer is an adhesive layer formed on a surface of the cloth layer, and oily vinyl acetate copolymer resin is infiltrated into fibers of the cloth layer. Dirt such as dust and particles attached on a surface of an object can be removed easily by the oily vinyl acetate copolymer resin-based adhesive layer with adhesiveness without causing scratches or damage to the surface of the object.

### BACKGROUND OF THE INVENTION

### Field of the Invention

The present invention relates to a wiping cloth, especially to an adhesive wiping cloth.

### DESCRIPTION OF RELATED ART

In the environment where people live, there are various types of suspended particulates including soil dust, industrial waste gas, pollens, dander, etc. in the air. The suspended particulates not only lead to respiratory system diseases, but also easily attach to things around us. In order to keep living environment clean and comfortable and maintain normal operation of precision machines, the suspended particulates should be cleaned and removed in time.

Yarns and fibers are woven or knitted to form fabric which is then cut and sewed to produce general wiping cloth. However, during wiping process, cotton fluff or lint of such kind of the wiping cloth is easily coming off. Thus the cotton fluff or lint is attached to the surface of the object instead of the dust and dirt after the wiping process. The surface of the object is still not clean after the wiping. For certain objects related to the fields including electronics, medical health, aviation, etc. which are highly sensitive to dust, wiping cloth available now is unable to be used for wiping and cleaning.

Thus there is room for improvement and there is a need to provide an adhesive wiping cloth which is not only able to solve the problem of the conventional wiping cloth which leaves fluff when use but also more convenient to use.

### SUMMARY OF THE INVENTION

Therefore, it is a primary object of the present invention to provide an adhesive wiping cloth which attracts and holds dust firmly due to its adhesive property, without cotton fluff coming off therefrom while in use.

In order to achieve the above object, an adhesive wiping cloth according to the present invention includes a cloth layer and an oily vinyl acetate copolymer resin-based adhesive layer formed on a surface of the cloth layer.

Preferably, the cloth layer is made of anti-static fabric.

Preferably, the oily vinyl acetate copolymer resin-based adhesive layer is an anti-static adhesive layer.

Preferably, the oily vinyl acetate copolymer resin-based adhesive layer is attached to the surface of the cloth layer by spraying.

Preferably, the oily vinyl acetate copolymer resin-based adhesive layer is attached to the surface of the cloth layer by immersion and then oily vinyl acetate copolymer resin is infiltrated into and distributed in fibers of the cloth layer.

Preferably, the surface of the cloth layer can be an upper surface of the cloth layer, a lower surface of the cloth layer, or their combinations.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a partial enlarged view showing an embodiment of an adhesive wiping cloth in which an oily vinyl acetate copolymer resin-based adhesive layer is formed on a surface of a cloth layer by spraying according to the present invention;

FIG. 2 is a partial enlarged view showing an embodiment of an adhesive wiping cloth in which an oily vinyl acetate copolymer resin-based adhesive layer is formed on a surface of a cloth layer by immersion and oily vinyl acetate copolymer resin is infiltrated into and distributed in fibers of the cloth layer according to the present invention.

### DETAILED DESCRIPTION OF THE PREFERRED EMBODIMENT

In order to learn technical content, purposes and functions of the present invention more clearly and completely, please refer to the following detailed descriptions with the figures and reference signs.

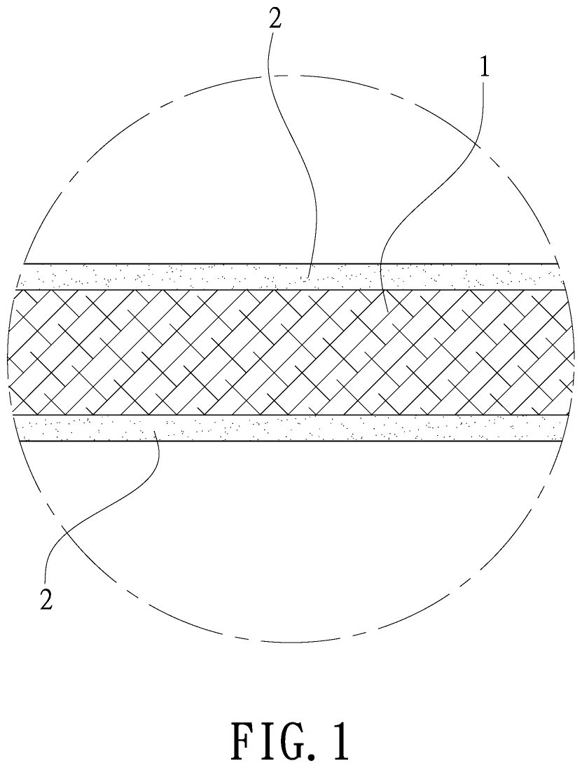

Refer to FIG. 1, a partial enlarged sectional view of an embodiment of an adhesive wiping cloth according to the present invention is provided.

The adhesive wiping cloth according to the present invention mainly includes a cloth layer 1 and an oily vinyl acetate copolymer resin-based adhesive layer 2.

The cloth layer 1 is formed by knitted or woven fibers.

The oily vinyl acetate copolymer resin-based adhesive layer 2 is made of oily vinyl acetate copolymer resin and formed on a surface of the cloth layer 1. In the embodiment shown in FIG. 1, the oily vinyl acetate copolymer resin-based adhesive layer 2 is attached to and formed on the surface of the cloth layer 1 by spraying.

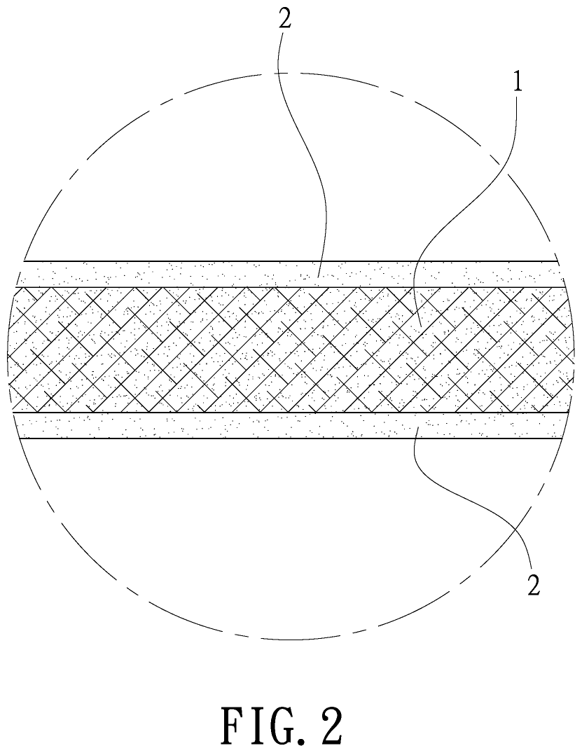

Refer to FIG. 2, another embodiment is provided. The difference between this embodiment and the one shown in FIG. 1 is in that the oily vinyl acetate copolymer resin-based adhesive layer 2 is attached to and formed on the surface of the cloth layer 1 by immersion, and then the oily vinyl acetate copolymer resin is infiltrated into and distributed in the cloth layer 1.

In the embodiments shown in FIG. 1 and FIG. 2, the oily vinyl acetate copolymer resin-based adhesive layer 2 is formed on the surface of the cloth layer 1 while the surface can be an upper surface of the cloth layer 1, a lower surface of the cloth layer 1, or their combinations.

In a preferred embodiment, the cloth layer 1 is made of anti-static fabric so that a product of the present adhesive wiping cloth provides anti-static effect.

In a preferred embodiment, the oily vinyl acetate copolymer resin-based adhesive layer 2 is added with anti-static ingredient so that a product of the present adhesive wiping cloth can get rid of static electricity.

The adhesive wiping cloth according to the present invention can be applied to wiping objects in different fields including electronic products (such as substrate), automobiles, airplanes, aviation, medical health, semiconductor, photonics, electronic devices, precision instruments, home cleaning, etc. The oily vinyl acetate copolymer resin-based adhesive layer 2 on the surface of the cloth layer 1 is adhesive so that dirt (such as dust and particles) on a surface of the object can be adhered and attached to the oily vinyl acetate copolymer resin-based adhesive layer 2. Thereby the dirt is removed easily without causing scratches or damage to the surface of the object.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An adhesive wiping cloth comprising:
a cloth layer and
an oily vinyl acetate copolymer resin-based adhesive layer which is formed on a surface of the cloth layer.

2. The adhesive wiping cloth as claimed in claim 1, wherein the surface is selected from the group consisting of an upper surface of the cloth layer, a lower surface of the cloth layer, and a combination thereof.

3. The adhesive wiping cloth as claimed in claim 2, wherein the cloth layer is made of anti-static fabric.

4. The adhesive wiping cloth as claimed in claim 3, wherein the oily vinyl acetate copolymer resin-based adhesive layer is formed on the surface of the cloth layer by spraying.

5. The adhesive wiping cloth as claimed in claim 4, wherein the oily vinyl acetate copolymer resin-based adhesive layer is an anti-static adhesive layer.

6. The adhesive wiping cloth as claimed in claim 2, wherein the oily vinyl acetate copolymer resin-based adhesive layer is formed on the surface of the cloth layer by spraying.

7. The adhesive wiping cloth as claimed in claim 6, wherein the oily vinyl acetate copolymer resin-based adhesive layer is an anti-static adhesive layer.

8. The adhesive wiping cloth as claimed in claim 1, wherein the oily vinyl acetate copolymer resin-based adhesive layer is formed on the surface of the cloth layer by spraying.

9. The adhesive wiping cloth as claimed in claim 8, wherein the oily vinyl acetate copolymer resin-based adhesive layer is an anti-static adhesive layer.

10. The adhesive wiping cloth as claimed in claim 1, wherein oily vinyl acetate copolymer resin is infiltrated into and distributed in fibers of the cloth layer when the oily vinyl acetate copolymer resin-based adhesive layer is formed by immersion.

11. The adhesive wiping cloth as claimed in claim 10, wherein the oily vinyl acetate copolymer resin-based adhesive layer is an anti-static adhesive layer.

12. The adhesive wiping cloth as claimed in claim 2, wherein oily vinyl acetate copolymer resin is infiltrated into and distributed in fibers of the cloth layer when the oily vinyl acetate copolymer resin-based adhesive layer is formed by immersion.

13. The adhesive wiping cloth as claimed in claim 12, wherein the oily vinyl acetate copolymer resin-based adhesive layer is an anti-static adhesive layer.

14. The adhesive wiping cloth as claimed in claim 3, wherein oily vinyl acetate copolymer resin is infiltrated into and distributed in fibers of the cloth layer when the oily vinyl acetate copolymer resin-based adhesive layer is formed by immersion.

15. The adhesive wiping cloth as claimed in claim 14, wherein the oily vinyl acetate copolymer resin-based adhesive layer is an anti-static adhesive layer.

16. The adhesive wiping cloth as claimed in claim 1, wherein the oily vinyl acetate copolymer resin-based adhesive layer is an anti-static adhesive layer.

17. The adhesive wiping cloth as claimed in claim 2, wherein the oily vinyl acetate copolymer resin-based adhesive layer is an anti-static adhesive layer.

18. The adhesive wiping cloth as claimed in claim 3, wherein the oily vinyl acetate copolymer resin-based adhesive layer is an anti-static adhesive layer.
